(19) United States
(12) Patent Application Publication
(10) Pub. No.: US 2011/0162912 A1
(43) Pub. Date: Jul. 7, 2011

(54) MODULARIZED MOBILE MATERIALS HANDLING TRUCK OR TROLLEY

(75) Inventor: Dean Rainsford, Dudley Park (AU)

(73) Assignee: OSKO FORKLIFTS PTY LTD, Dudley Park (AU)

(21) Appl. No.: 11/989,872

(22) PCT Filed: Aug. 2, 2006
(86) PCT No.: PCT/AU2006/001084

§ 371 Date: May 4, 2010

(30) Foreign Application Priority Data
Aug. 4, 2005 (AU) 2005904172

(51) Int. Cl. B66F 9/075; B66F 9/06

(52) U.S. Cl. 187/222

(57) ABSTRACT

The invention provides a modular lift truck unit (10) comprising three separate modules, namely a front mast module (11), a rear power or drive unit module (12) and an intermediate counterbalancing module (13). The rear side of the mast module is detachably bolted to the front side of the counter weight module (13), while the rear side of the counter weight module is detachably bolted to front of the power or drive unit module (12). The modules (11, 12, 13) are provided with matching connection points to enable each of the modules to be detachably secured to another module by a plurality of securing bolts.

This invention relates to an improved materials handling lift truck or trolley having a modular construction which permits the truck/trolley to be used in a number of different configurations, for example, as a non-counterbalanced stacker unit or as a counterbalanced forklift unit.

Forklift trucks having a modular construction are known in the industry and generally comprise a chassis or base module, a mast module and a power module, with the modules being detachably bolted together. Modular forklift truck designs of this kind are disclosed in GB 1462688, DE 19908201 and JP 2002003188. By modularising the construction of the lift truck, the customer's requirements can be more easily met while at the same time minimising inventory requirements on the part of the distributor of the equipment. Obviously to carry in stock a complete line of lift trucks of varying characteristics for delivery to customers, requires a very large inventory.

While the use of a modular concept has proven beneficial in satisfying customer's requirements so far as being able to assemble a particular type or model of lift truck having different characteristics, existing modular concepts have the limitation of not being able to accommodate customer requirements for different types or models of lift trucks, such as a non-counterbalanced stacker on the one hand and a counterbalanced fork lift truck on the other hand.

It is the main object of the present invention to provide an improved modular construction for a masted lift truck assembly which allows the truck to be converted from one type of lift truck which is not counterbalanced to another type or model of lift truck which is counterbalanced, in a simple and inexpensive manner.

It is another object of the present invention to provide an improved modular materials handling masted lift truck which allows the product distributor to minimise inventory requirements, while still being able to conveniently produce a lift truck to suit the customer's exact specifications.

It is a still further object of the present invention to provide an improved masted lift truck of modular construction wherein at least two modules are common to different versions or models of the lift truck of a given capacity.

According to this invention therefore, there is provided a modular masted lift truck unit comprising a front mast module, a rear power or drive section module, and an intermediate counterweight module, wherein said counterweight module is detachably secured to each of said front and rear modules.

Preferably, the counterweight module is provided with a pair of transversely spaced apart support wheels or rollers on opposite sides thereof adjacent the front end of the module.

Preferably, the drive section module comprises forwardly projecting locating lugs which slidably engage in respective sockets or channels having openings in the rear face of the counterweight module to facilitate the interconnection of the two modules.

Generally the mast module will incorporate a fork lift arrangement which is guided for vertical up and down movement along the vertical mast. In some instances, the mast module will have a base frame comprising a pair of forwardly projecting base arms each of which carries at its forward end a support wheel or roller.

With this invention, one is able to utilise two of the modules to produce a non-counterbalanced stacker unit but also to convert this unit to a counterbalanced forklift unit by incorporating the counterweight module. It will be appreciated therefore that the customer has the benefit of having two different types or models of lift trucks produced from three modules only, with each of the units using the same drive section module and mast module. It is also possible to readily replace one counterweight module with another counterweight module of different weight for a counterbalanced forklift unit.

It will be appreciated that the simple modular construction of this invention allows the product distributor to minimise his stock holding by carrying stocks of the three different types of modules and then under factory direction, assemble the unit together to suit the customer's specific requirements. For example, a distributor can hold stock of some eight modules and be able to cover the complete product range whereas, according to existing practices, the distributor would need to hold 28 complete fork lift units to stock the entire finished range. This represents a stocking cost of approximately 8% of the present required stock holding and gives the distributor the advantage of being able to supply product within hours of a customer order being placed. It also allows the distributor to manipulate the sale to suit his stock holding.

In order to more fully explain the present invention, an embodiment is described hereunder in some further detail with reference to and as illustrated in the accompanying drawings wherein:

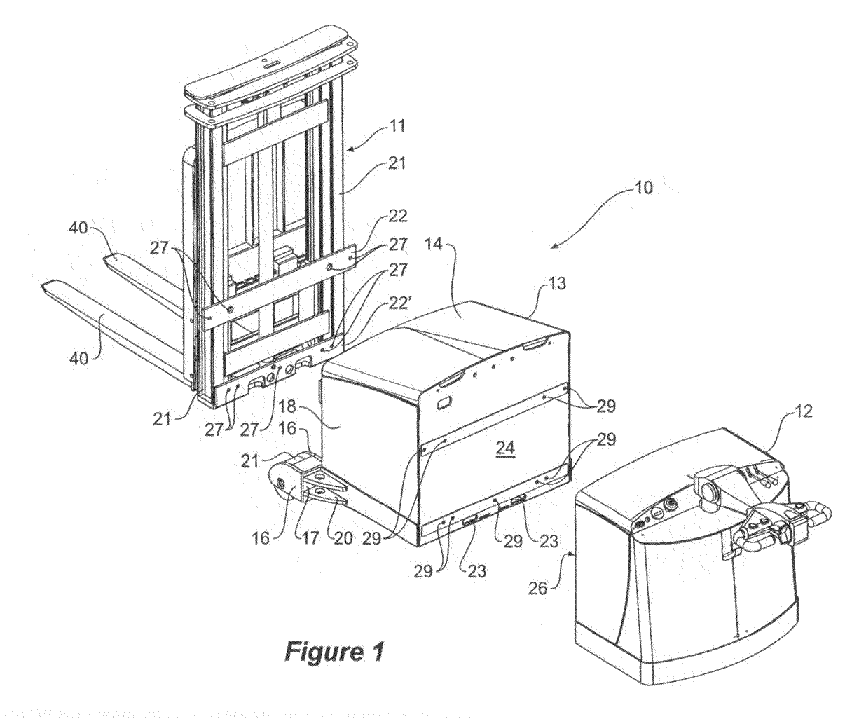

FIG. 1 is an exploded perspective view of a modular masted lift truck unit produced in accordance with the present invention;

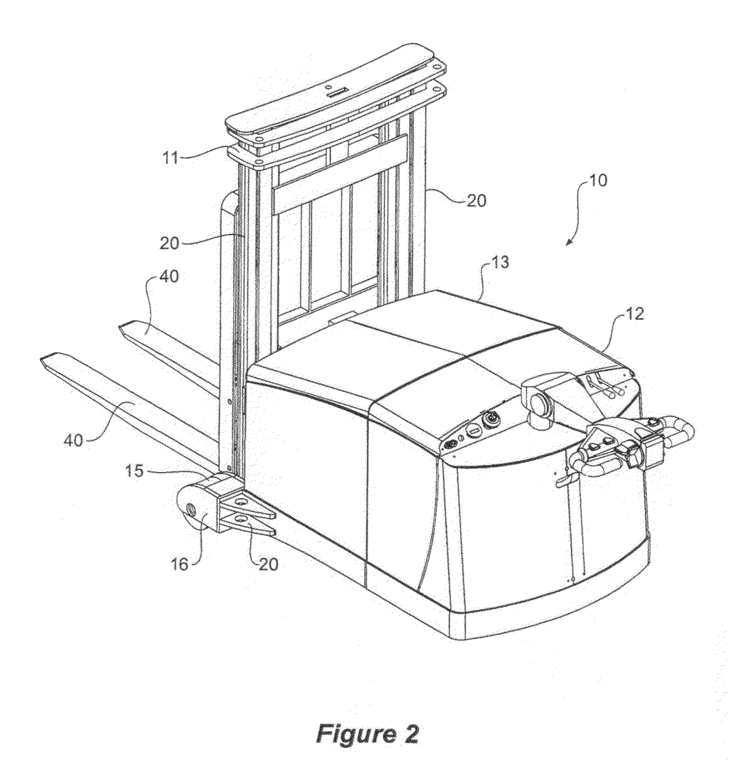

FIG. 2 is a perspective view of the lift truck unit shown in FIG. 1, when in its assembled condition;

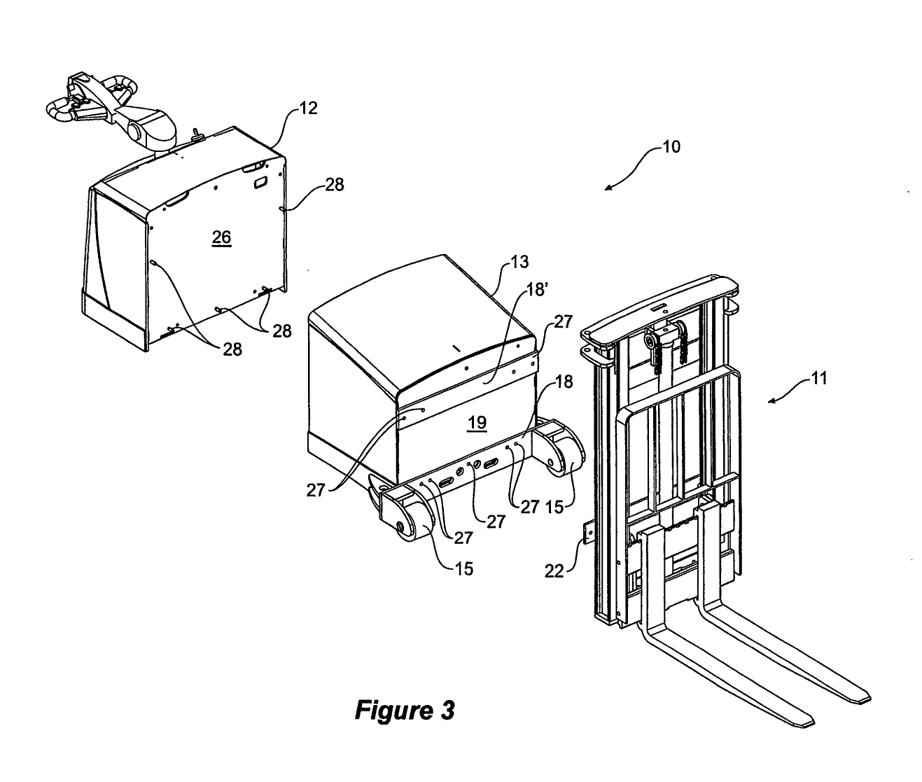

FIG. 3 is an exploded front perspective view of the unit shown in FIG. 1;

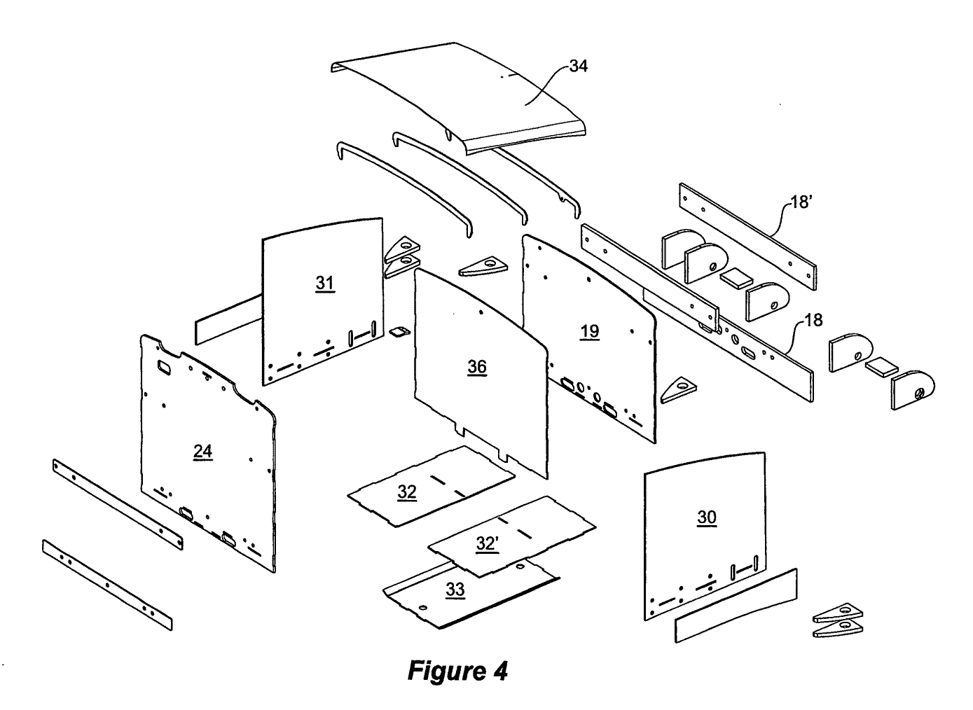

FIG. 4 is an exploded perspective view of the counterbalancing module only (the weight(s) being omitted); while

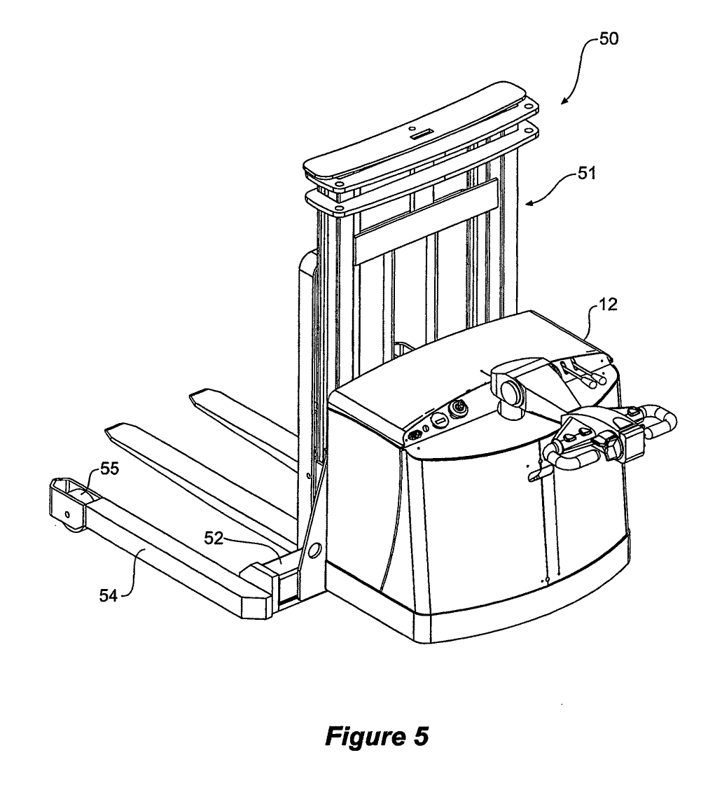

FIG. 5 is a perspective view of a non-counterbalanced stacker unit wherein the mast module and drive section module shown in FIG. 1 are directly bolted to one another.

Referring to FIGS. 1 and 2 of the drawings, there is disclosed a counterbalanced fork lift stacker unit 10 which is comprised of three different modules, a front mast module 11, a rear power or drive unit module 12 and an intermediate counterweight or counterbalancing module 13. The rear side of the mast module 11 is detachably bolted to the front side of the counterweight module 13, while the rear side of the counterweight module 13 is detachably bolted to the front of the power or drive unit module 12.

The drive unit module 12 has, in accord with known art, operating controls to control the operation of the mast section and other devices and also a driven steerable wheel (not shown).

In this embodiment, the counterweight module 13 comprises a housing 14 provided with support wheels or rollers 15 adjacent each of its front corners, with each wheel or roller 15 being rotatably supported between a pair of forwardly projecting metal bracket arms 16 which join to a rear web 17 secured by welding to a brace member 18 which in turn is welded to the front wall 19 of the counterweight housing 14. A reinforcing gusset 20 is used to rigidly secure each web 17 to the side of the housing 14. As shown in FIG. 2, the support wheels 15 straddle the mast uprights 21 of the fixed mast section of the mast module 11.

The mast module 11 has attachment plates 22, 22′ which bridge the uprights 21 and align with and abut transverse brace members 18, 18′ welded to the front panel 19 of the housing 14. The attachment plates 22, 22′ and brace members 18, 18′ are provided with matching holes 27 permitting the mast module 11 to be quickly and easily secured by bolts (not shown) located through the holes 27 to the front of the counterweight module 13.

As shown in FIG. 3, front wall 26 of the module 12, is formed with holes which locate a series of threaded studs or bolts 28 which pass through matching holes 29 formed in the facing wall 24 of the module 13, the studs or bolts 28 being used to securely attach the two modules 12, 13 together with the walls 24, 26 in contiguous relation.

As shown in FIG. 4, the counterweight housing 14 comprises front wall panel 19, rear wall panel 24, opposite side wall panels 30, 31, floor panels 32, 32′, and bottom panel 33, the panels being interconnected by tongue and slot joints. A cover or lid 34 is removably located on top of the housing 14. A transverse partition wall 36 can be used to divide the interior of the housing into separate compartments, one of which can be used to store weights, the other, for example, batteries.

It will be appreciated that the counterweight module 13 is used to counterbalance the lift truck unit during a lifting operation when a load is lifted by the lifting forks 40 which are guided for vertical up and down movement along the height of the mast frame of the mast module 11. The counterweight module 13 prevents rearward overturning of the truck by the load carried by the lifting forks 40.

The weights (not shown) used for counterbalancing are housed in the interior of housing 14 and detachably secured in position by anchoring bolts which pass through holes formed in the weights and the rear panel 24 of the housing 14.

It is an advantage of the present invention that counterbalanced fork lift stacker units of different capacities can be produced each having the same drive unit module and the same mast module, with only a different counterweight module being employed. Of course, different types of mast modules can also be employed particularly where different lift heights are required.

Referring now to FIG. 5 of the accompanying drawings, there is shown a non-counterbalanced fork lift truck unit 50 which comprises a self-supporting mast module 51 which is directly bolted to the power or drive module unit 12 being the same as that used in the embodiment shown in FIGS. 1 and 2. In this instance, there is no counterweight module located between the mast module 51 and power or drive unit module 12. The mast module 51 comprises a base frame 52 which includes a pair of forwardly projecting base arms 54 on opposite sides of the base frame 52, with each arm supporting a wheel or roller 55 at its leading or forward end. The drive unit module 12 is rendered mobile by means of a drive wheel (not shown).

In another variation, the drive unit module 12 can be directly bolted to the mast module 11 shown in FIG. 1 so as to provide a non-counterbalanced stacker unit having a lifting capacity low enough so as to not require a counterweight module. This is made possible by having matching connection points in the front walls of the modules 12,13 and the transverse attachment plates affixed to the rear of the mast module 11, thereby enabling either module 12, 13 to be bolted directly to the mast.

While the above described embodiments have been given by way of illustrative example of the present invention, many variations and modifications thereto will be apparent to those skilled in the art without departing from the broad ambient and scope of the invention.

A brief consideration of the above described embodiments will indicate that the invention provides a novel modularised concept for masted lift truck units which not only provides manufacturing/production efficiencies but also the ability to convert from one type of fork lift vehicle which does not require counterbalancing to one which can be readily and conveniently counterbalanced while utilising at least one module common to both models. Through the use of this new novel modular concept, the inventory of parts and finished fork lift units can be greatly reduced without affecting the manufacturer's or distributor's capability of supplying customers with a fork lift unit having particular characteristics.

1. A modular masted lift truck unit comprising:
a front mast module,
a rear power, and
an intermediate counterweight module, wherein said counterweight module is detachably secured to each of said front and rear modules.

2. A modular masted lift truck unit according to claim 1 wherein said rear module can be detachably secured directly to said front module to provide a non-counterbalancing unit.

3. A modular masted lift truck unit according to claim 1 wherein said counterweight module is provided with a pair of transversely spaced apart support wheels or rollers on opposite sides thereof, said support wheels or rollers being located forwardly of the front end of the counterweight module and laterally spaced apart by a distance sufficient to accommodate the front mast module therebetween.

4. A modular masted lift truck unit according to claim 1 wherein said counterweight module comprises a housing having opposed front and rear wall panels, a pair of opposite side wall panels and a bottom panel, said housing defining an open top chamber for housing counterweight material.

5. A modular masted lift truck unit according to claim 4 further comprising a removable cover or lid for closing off the open top of the housing.

6. A modular masted lift truck unit according to claim 4 wherein said counterweight material defines a plurality of apertures and is detachably secured within said housing by means of bolts passing through aligned apertures formed in the counterweight material and the rear wall panel of the housing.

7. A modular masted lift truck unit according to claim 4 wherein said front mast module comprises a fixed mast section comprised of a pair of transversely spaced apart upright frame members and a pair of transverse attachment plates secured to and bridging said upright frame members on the rear side of the fixed mast section, wherein the front wall of said counterweight module and said attachment plates have matching apertures to enable the front mast module and the counterweight module to be secured directly to one another in contiguous relationship by a plurality of bolts.

8. A modular masted lift truck unit according to claim 7 wherein the rear wall of said counterweight module and the front wall of said rear module are provided with matching bolt locating apertures to permit the intermediate and rear modules to be secured directly to one another in contiguous relationship by a plurality of securing bolts or studs.

9. A modular masted lift truck unit according to claim 8 wherein the apertures formed in the front wall of the rear module also match the apertures formed in the attachment plates on the mast module.

10. A modular masted lift truck unit according to claim 7 wherein said mast module is provided with a fork lift section which is guided for vertical up and down movement along said fixed mast section.

11. A modular masted lift truck unit according to claim 10 wherein said fixed mast section comprises a base frame having a pair of forwardly projecting base arms each of which carries at its forward end a support wheel or roller.

12. (canceled)

13. A modular masted lift truck unit according to claim 2 wherein said counterweight module is provided with a pair of transversely spaced apart support wheels or rollers on opposite sides thereof, said support wheels or rollers being located forwardly of the front end of the counterweight module and laterally spaced apart by a distance sufficient to accommodate the front mast module therebetween.

14. A modular masted lift truck unit according to claim 13 wherein said counterweight module comprises a housing having opposed front and rear wall panels, a pair of opposite side wall panels and a bottom panel, said housing defining an open top chamber for housing counterweight material.

15. A modular masted lift truck unit according to claim 14 wherein said front mast module comprises a fixed mast section comprised of a pair of transversely spaced apart upright frame members and a pair of transverse attachment plates secured to and bridging said upright frame members on the rear side of the fixed mast section, wherein the front wall of said counterweight module and said attachment plates have matching apertures to enable the front mast module and the counterweight module to be secured directly to one another in contiguous relationship by a plurality of bolts.

16. A modular masted lift truck unit according to claim 5 wherein said front mast module comprises a fixed mast section comprised of a pair of transversely spaced apart upright frame members and a pair of transverse attachment plates secured to and bridging said upright frame members on the rear side of the fixed mast section, wherein the front wall of said counterweight module and said attachment plates have matching apertures to enable the front mast module and the counterweight module to be secured directly to one another in contiguous relationship by a plurality of bolts.

17. A modular masted lift truck unit according to claim 8 wherein said mast module is provided with a fork lift section which is guided for vertical up and down movement along said fixed mast section.

18. A modular masted lift truck unit according to claim 9 wherein said mast module is provided with a fork lift section which is guided for vertical up and down movement along said fixed mast section.

19. A modular masted lift truck unit according to claim 15 wherein the rear wall of said counterweight module and the front wall of said rear module are provided with matching bolt locating apertures to permit the intermediate and rear modules to be secured directly to one another in contiguous relationship by a plurality of securing bolts or studs.

20. A modular masted lift truck unit according to claim 19 wherein the apertures formed in the front wall of the rear module also match the apertures formed in the attachment plates on the mast module.

21. A modular masted lift truck unit according to claim 20 wherein said mast module is provided with a fork lift section which is guided for vertical up and down movement along said fixed mast section and wherein said fixed mast section comprises a base frame having a pair of forwardly projecting base arms each of which carries at its forward end a support wheel or roller.
